(19) United States
(12) Patent Application Publication
(10) Pub. No.: US 2012/0264597 A1
(43) Pub. Date: Oct. 18, 2012

(54) CEAlO3 PEROVSKITES CONTAINING TRANSITION METAL

(75) Inventors: Radhamonyamma Nandini Devi, Pune (IN); Satyanarayana Veera Venkata Chilukuri, Pune (IN)

(73) Assignee: COUNCIL OF SCIENTIFIC & INDUSTRIAL RESEARCH, New Delhi (IN)

(21) Appl. No.: 13/384,961

(22) PCT Filed: Jul. 20, 2010
(86) PCT No.: PCT/IN2010/000482

§ 371 Date: Jan. 19, 2012

(30) Foreign Application Priority Data
Jul. 20, 2009 (IN) 1477/DEL/2009

(51) Int. Cl. B01J 21/02; C01F 17/00

(52) U.S. Cl. 502/304; 423/263

(57) ABSTRACT

Disclosed herein is a perovskite represented by the following Formula (I): A_{χ}A′_{(1-χ)}B_{(1-y)}B′_{y}O_{3-δ} wherein A and A′ represent at least one element selected from trivalent rare earth elements of lanthanide and actinide series, including La, Ce, Pr, Nd, Sm, Eu, Gd, Tb, Dy, Th; B represents at least one element selected from Sc and group IMA elements including, but not limited to Al, Ga, In; B′ is at least one element selected from transition metals but not limited to Ni, Cu, Co, Fe, Mn, Pt, Pd, Rh1 Ru, Ir, Ag, Au wherein x=0 −1; 0<y<0.2 for noble metals, 0<y≦0.5 for transition metals other than noble metals and δ represents oxygen deficiency. Further, —the low temperature processes to prepare the pervoskite and its uses are disclosed herein.

### TECHNICAL FIELD OF THE INVENTION

The present invention relates to perovskite-type composite oxide represented by the general formula A_{X}A′₍₁₋ₓ₎B_{(1-y)}B′_{y}O_{3-δ}. Particularly the invention relates to transition metal containing CeAlO₃ family of perovskites and a catalyst composition containing the perovskite-type composite oxide.

### BACKGROUND AND PRIOR ART

Perovskites are a large family of crystalline ceramics that derive their name from a specific mineral known as perovskite (CaTiO₃) due to their crystalline structure. They are represented by the general chemical formula ABX₃, where ‘A’ and ‘B’ are cations of very different sizes and valencies, X is an anion that bonds to both. Perovskites material finds various industrial applications and is used as sensors and catalyst electrodes in certain types of fuel cells.

Hydrogen is projected as the most attractive alternative energy source in the scenario of depleting fossil fuels. Even though hydrogen is produced in large scale currently, mainly for ammonia plants, the technology is fraught with challenges, when adapted to small scale and household applications. The technology involves initial steam reforming and partial oxidation of hydrocarbons and later intermediate clean up processes like water gas shift reaction, which is necessary to reduce the CO concentration as well as generate additional hydrogen. Existing processes utilize base metal catalysts which need extensive pretreatments not conducive for domestic applications. Moreover, these catalysts deactivate rapidly under frequent on-off procedures and are pyrophoric on exposure to air as warranted in such cases. Further, in such catalysts the noble metals and transition metals are supported on the oxides, and not incorporated in the lattice.

U.S. Pat. No. 2006182679 titled “Precious Metal water-gas shift catalyst with oxide support modified with rare earth elements” relates to a catalyst containing a platinum metal group dispersed on rare earth oxide-alumina support, wherein the rare earth oxide is selected from lanthanum, cerium, gadolium, paraseodymium, neodymium etc. The catalyst may contain an alkali metal compound added to the said modified inorganic oxide support in order to enhance its activity. The catalysts are used in conducting water-gas shift reaction, in generating hydrogen in the gas stream supplied to fuel cells. Pt loaded cerium-oxide modified alumina support is however found to be highly unstable during a water gas shift reaction.

Article titled “Platinum Group Metal Perovskite Catalysts” by Thomas Screen, Volume 51, Issue 2, April 2007, Pages 87-92, and having DOI 10.1595/147106707X192645 discloses palladium-containing perovskite LaFe0.77Cu0.17Pd0.0603, synthesized by co-precipitation of the metal nitrates, as auto catalysts.

EP 0715879 titled “Catalyst for purifying exhaust gases and process for producing the same” describes cerium oxide or a solid solution of cerium oxide and zirconium oxide in a state of mutual solid solution loaded on the porous support preferably alumina. Noble metal such as Pt, Pd, Rh are then loaded on the said porous support. The EP '879 catalyst as disclosed is therefore a solid solution and is not structured as a pervoskite. Further, the catalytically active metal being only supported on mixed oxide, is prone to deactivation by agglomeration.

US2007213208 discloses a perovskite system of the formula AₓB_{(1-y)}PdyO_{3+δ} wherein ‘A’ represents at least one element selected from rare earth elements and alkaline earth metals; S′ represents at least one element selected from transition elements (excluding rare earth elements, and Pd), Al and Si; x represents an atomic ratio satisfying the following condition: 1<x; y represents an atomic ratio satisfying the following condition: 0<y<=0.5; and δ[delta] represents an oxygen excess. More specifically, it represents an excessive atomic ratio of oxygen atom caused by allowing the constitutional elements of the A site to be excessive to the stoichiometric ratio of a perovskite type composite oxide of A:B:O=1:1:3.

The perovskite system specifically belongs to LaFeO₃ (ABO₃) type of system wherein the inventors have substituted various rare-earth and alkaline-earth elements in La position (A position) while simultaneously attempting substitution of aluminium, silicon, transition metals along with Pd in ‘B’ position (in place of Fe). Further, preparation of said perovskite type composite oxide involves heat treatment in air resulting in the formation of oxygen rich composition. However, said patent fails to mention the substitution of precious metals such as Pt, Rh, Ru, Re, Ir etc in the perovskite system.

A prior art search related to noble metal and transition metal reveals that though platinum supported on high surface area ceria based oxide systems show good water gas shift reaction activity, this is dependent on the particle size of platinum and is also temperature dependent. Further, at higher temperatures the noble metal undergoes sintering resulting in decreasing surface area and subsequent reduction of activity. Moreover, the perovskite-type oxide systems are oxygen rich thereby decreasing the stability of the lattice under reducing conditions.

The problem has been addressed by alloying and utilization of bimetallic systems like Pt—Re. Even though Re is reported to minimize the on-stream sintering of Pt nanoparticles, these bimetallic catalysts however show deactivation after long operational durations and frequent shut off-on procedures.

Hence, in view of the above, there remains a need to develop stable catalysts for fuel processors, based on perovskite framework materials.

Since ceria based supports play an important role in the activity of WGS catalysts, CeAlO₃ perovskite with isomorphously substituted aluminum ions with platinum to create lattice vacancies as well as create Ce³⁺/Ce⁴⁺ redox systems conducive for WGS reaction were attempted. Moreover, if the metal ions are incorporated in the structured oxide lattice, then the possibility of agglomeration is very low thus increasing the stability and activity of the catalysts. This remains the object of the present invention.

### OBJECT OF INVENTION

In view of the above, it is thus the objective of the present invention to provide a Ce—Al—O system with noble metals, where the sintering of noble metal is prevented.

Another objective of the invention is to structurally incorporate the noble metal active centers in stable lattice networks under highly reducing conditions.

One more objective of the invention is to provide a Ce—Al—O based system with a transition metal, where the transition metal is not sintered.

Yet another objective of the invention is to structurally incorporate the transition metal active centers in stable lattice networks.

Another objective of the invention is to provide a low temperature process for Ce—Al—O system with noble metals, where the sintering of noble metal is prevented.

### SUMMARY OF THE INVENTION

The present invention has been developed in view of the aforementioned circumstances.

Accordingly the present invention discloses a perovskite with cerium that has a redox behaviour, useful as a catalyst in reactions including hydrogen generation and processing steps involving high temperatures, along with a stabilizing element with no redox behaviour.

Further, the invention relates to CeAlO3 perovskite of type A⁺³B⁺³O₃.

In one embodiment, the current invention describes a perovskite wherein a noble metal is inserted into the lattice in an oxygen deficient system. Accordingly, aluminium ions (Al³⁺) in CeAlO3 system are partially substituted with platinum ions (Pt²⁺) to create lattice vacancies conducive for water gas (WGS) shift reactions.

Thus a catalyst composition containing a perovskite-type composite oxide is provided which is represented by the general Formula (I)

AₓA′₍₁₋ₓ₎B_{(1-y)}B′_{y}O_{3-δ}

wherein A and A′ represent at least one element selected from trivalent rare earth elements of lanthanide and actinide series selected from La, Ce, Pr, Nd, Sm, Eu, Gd, Tb and Dy; B represents at least one element selected from Sc and group IIIA elements, but not limited to Al, Ga and In; B′ is at least one element selected from transition metals but not limited to Ni, Cu, Co, Fe, Mn, Pt, Pd, Rh, Ru, Ir, Ag, Au wherein x=0−1; 0≦y≦0.2 for noble metals, 0≦y≦0.5 for transition metals other than noble metals and δ represents oxygen deficiency to form a stable lattice network.

In another aspect, the invention discloses a low temperature process for the preparation of the pervoskite, where the temperature is ≦750° C.

Further, the pervoskite of the current invention are useful as catalysts in reactions for generation of hydrogen, water gas shift reaction, auto thermal reforming, steam reforming, CO₂ reforming, partial oxidation and such like.

### DESCRIPTION OF DRAWINGS

FIG. 1: XRD patterns of 2 and 4 wt % Rh and Pt incorporated into CeAlO₃ perovskite which shows the formation of the framework without any impurity phase.

FIG. 2 is XPS graph showing the presence of Pt in 2+ and Rh in 3+ state in case of Pt and Rh incorporated perovskites.

FIG. 3: ATR of methane on Ce_{1.0}Al_{0.975}Rh_{0.02}Pt_{0.005} catalyst at various space velocities.

FIG. 4: LPG conversion of using Ce_{1.0}Al_{0.975}Rh_{0.02}Pt_{0.005} catalyst.

FIG. 5: WGS of Pt containing perovskite catalysts with y=0.02 and 0.05

FIG. 6: Effect of space velocity on water gas shift activity on PtCeAlO₃₋. perovskite catalyst. Feed: H2:40%, N2:35%, CO: 10%, CO2: 15%; H2O: 40%, Temp. 350° C.

### DETAILED DESCRIPTION OF THE INVENTION

The invention will now be described in detail in connection with certain preferred and optional embodiments, so that various aspects thereof may be more fully understood and appreciated.

As herein described ‘Perovskite’ is the name of a group of compounds which take the same structure. The basic chemical formula follows the pattern ABO₃, where A and B are cations of different sizes and valencies.

Accordingly, the invention discloses a novel perovskite represented by the following Formula (I):

AₓA′₍₁₋ₓ₎B_{(1-y)}B′_{y}O_{3-δ}

wherein A and A′ represent at least one element selected from trivalent rare earth elements of lanthanide and actinide series, including La, Ce, Pr, Nd, Sm, Eu, Gd, Tb, Dy, Th; B represents at least one element selected from Sc and group IIIA elements including, but not limited to Al, Ga, In; B′ is at least one element selected from transition metals but not limited to Ni, Cu, Co, Fe, Mn, Pt, Pd, Rh, Ru, Ir, Ag, Au wherein x=0−1; 0≦y≦0.2 for noble metals, 0≦y≦0.5 for transition metals other than noble metals and δ represents oxygen deficiency. The perovskite of the invention forms a stable lattice network as exemplified herein below in examples 5 and 6.

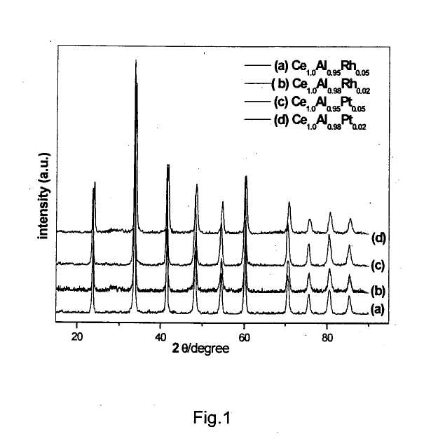

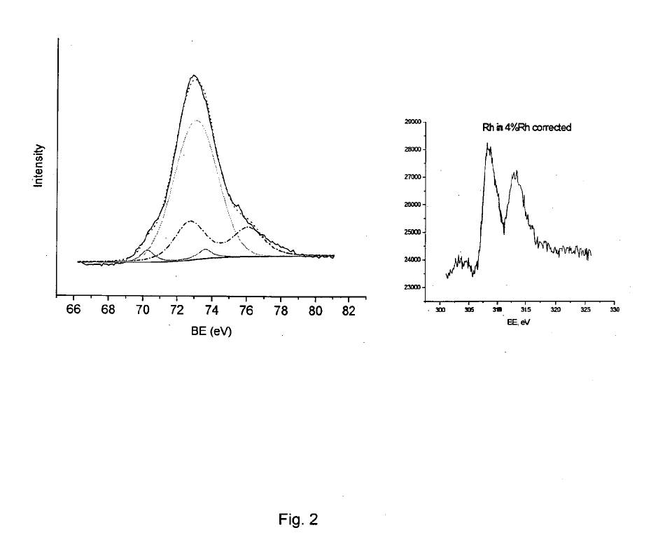

The transition metals including noble metals are incorporated in the stable lattice network of the perovskite than the system supporting the metals, thus overcoming the shortcoming of sintering of transition metal in prior arts as is seen in FIGS. 1 and 2.

Thus in an embodiment, transition metals including noble metals are incorporated in the stable lattice network of the perovskite under reduced conditions thus leading to oxygen deficient material which is useful for ATR (autothermal reforming), WGS (water gas shift), dry reforming and such like. Further, incorporation of the noble metals into the lattice structure prevents sintering of the metals enabling its use at higher temperature and overcoming the-problem of catalytic deactivation.

The noble metals such as Pt and Rh are stabilized in its ionic form as they are locked in the structure (preventing sintering of metal particles, catalyst deactivation), thus yielding highly stable catalysts under highly reducing conditions. The noble metals (Pt, Rh, Au) substituted in the perovskite structure is up to at least 5%. The surface area of the pervoskite of the invention is 20-30 m²/g, as determined by the Nitrogen adsorption method, well known in literature.

In a preferred embodiment, pervoskites of the invention are prepared by low temperature processes as described herein.

Accordingly, the perovskite is prepared by the low temperature citrate process, wherein the temperature is ≦750° C. comprising:
a) stirring an aqueous solution of cerium and aluminum nitrate in molar ratio Ce:Al 1:1 at 60° C. for 2 h after the addition of citric acid in a little excess of the molar amount of Ce and Al;
b) stirring and heating the solution of step (a) up to 80° C. to obtain a spongy material after evaporation of water;
c) heating the spongy material thus obtained in step (b) at 200° C. for 2 h to decompose the organic matter;
d) calcining the material thus obtained in step (c) at 500° C. for 3 h in air to form a precursor; and
e) reducing the precursor thus formed in step (d) in a flow of H₂ (4-30 mL/min) at temperature ≦750° C. for 5 h to obtain CeAlO₃ perovskite.

For noble/transition metal incorporation, the corresponding salt of the noble/transition metal in appropriate ratio is added to the initial metal solution mixture as described in step (a) to obtain CeAl_{1-y}B′_{y}O_{3-δ}

By the process described herein, other transition metals including precious metals are incorporated in the perovskite of the invention as exemplified herein in examples 1 to 6.

According to the co-precipitation process, also a low temperature process, an aqueous mixed salt solution containing salts (materials) of the respective elements is prepared so as to establish the above-mentioned stoichiometric ratio of the respective elements followed by co-precipitating by adding a neutralizing agent thereto; the resulting co-precipitate is dried and then subjected to a heat treatment.

The perovskites of the invention prepared by the low temperature co-precipitation process, wherein the temperature is 750° C. is described below:
(a) co-precipitating cerium and aluminium in 1:1 molar ratio in presence of KOH as precipitating agent by simultaneous addition and vigorous stirring at about 80° C. forming a gel;
(b) adjusting the pH of gel as formed in step (a) to ˜9-10.5, aging the gel at 80° C. for 12 h to obtain a precipitate;
(c) washing the precipitate thus obtained in step (b) with water till to obtain pH 7.5;
(d) drying the precipitate of step (c) at 100° C. for about 12 h and calcining in air at 500° C. for 3 h to form a precursor and;
(e) reducing the precursor formed in a flow of H₂ (4-30 mL/min) at temperature ≦750° C. for 5 h to obtain CeAlO₃ perovskite

For noble/transition metal incorporation, the corresponding salt of the noble/transition metal in appropriate ratio is added to the initial metal solution mixture as described in step (a) to obtain CeAl_{1-y}B′_{y}O_{3-δ}

Examples of the neutralizing agent are ammonia, urea; organic bases including amines such as triethylamine and pyridine; and inorganic bases like sodium and potassium hydroxide, sodium, potassium and ammonium carbonates. The neutralizing agent is added to the aqueous mixed salt solution to adjust the pH in the range of 6 to about 10.

A hydrothermal low temperature process, wherein the temperature is ≦750° C. for preparation of the perovkite of present invention is as follows:
(a) precipitating aqueous solutions of cerium and aluminum in the molar ratio 1:1 with ammonia solution to obtain a gel;
(b) transferring the gel formed in step (a) to teflon lined stainless steel autoclave and heating it at 200° C. in oven to obtain a precipitate;
(c) filtering and drying the precipitate of step (b) at 100° C. followed by calcination in air at 500° C. to form a precursor and
(d) reducing the precursor formed in step (c) in flow of H₂ (4 ml/min) at temperature ≦750° C. at five hours to obtain CeAlO₃ perovskite.

For noble/transition metal incorporation, the corresponding salt of the noble/transition metal in appropriate ratio is added to the initial metal solution mixture as described in step (a) to obtain CeAl_{1-y}B′_{y}O_{3-δ}

Such perovskites are used as catalysts in hydrogen production and utilization for a number of reactions including, but not restricted to water gas shift reactions, steam reforming, auto thermal reforming, partial oxidation, CO₂ reforming use of catalyst of the invention for the various reaction as described herein is independent of source of fuel selected from the group comprising LPG, methane, ethanol and lower hydrocarbons up to 8 carbons and such like as exemplified herein.

### INDUSTRIAL APPLICABILITY

The perovskite-type composite oxide of the present invention can be widely used in, reforming reactions including steam reforming, CO₂ reforming and autothermal reforming, water gas shift reaction, hydrogenation reactions, hydrogenolysis reactions and as electrolyte materials in fuel cells.

The following examples, which include preferred embodiments, will serve to illustrate the practice of this invention, it being understood that the particulars shown are by way of example and for purpose of illustrative discussion of preferred embodiments of the invention.

### EXAMPLES

### Example 1

### CeAlO₃ Perovskite

(a) An aqueous solution of cerium nitrate (5.9 g), aluminum nitrate (5.1 g), and citric acid (7 g) were stirred at 60° C. for 2 h;
(b) the solution was stirred and heated up to 80° C. to obtain a spongy material after evaporation of water;
(c) the spongy material obtained in step (b) was heated at 200° C. for 2 h to decompose the organic matter; followed by calcining the material at 500° C. for 3 h in air and
(d) The precursor formed in step (c) was reduced in a flow of H₂ (30 mL/min) at temperature ≦750° C. for 5 h to obtain CeAlO₃ perovskite

### Example 2

### Perovskite with Rhodium

(e) An aqueous solution of cerium nitrate (5.9 g), aluminum nitrate (5 g), rhodium nitrate (0.0784 g) and citric acid (7 g) were stirred at 60° C. for 2 h;
(f) the solution was stirred and heated up to 80° C. to obtain a spongy material after evaporation of water;
(g) the spongy material obtained in step (b) was heated at 200° C. for 2 h to decompose the organic matter; followed by calcining the material at 500° C. for 3 h in air and

(h) The precursor formed in step (c) was reduced in a flow of H₂ (30 mL/min) at temperature ≦750° C. for 5 h to obtain CeAl_{1-y}Rh_{y}O_{3-δ} perovskite (y=0.02).

### Example 3

### Perovskite with Palladium

(a) An aqueous solution of cerium nitrate (11.57 g), aluminum nitrate (10 g) and palladium nitrate (0.0577 g) and citric acid (7 g) were stirred at 60° C. for 2 h
(b) the solution was stirred and heated up to 80° C. to obtain a spongy material after evaporation of water;
(c) the spongy material obtained in step (b) was heated at 200° C. for 2 h to decompose the organic matter; followed by calcining the material at 500° C. for 3 h in air and
(d) the precursor formed in step (c) was reduced in a flow of H₂ (30 mL/min) at temperature ≦750° C. for 5 h to obtain CeAl_{1-y}Pd_{y}O_{3-δ} perovskite (y=0.02).

### Example 4

### Perovskite with Nickel

(a) An aqueous solution of cerium nitrate (12.18 g), aluminum nitrate (10 g) and nickel nitrate (0.407 g) and citric acid (7 g) were stirred at 60° C. for 2 h after
(b) the solution was stirred and heated up to 80° C. to obtain a spongy material after evaporation of water;
(c) the spongy material obtained in step (b) was heated at 200° C. for 2 h to decompose the organic matter; followed by calcining the material at 500° C. for 3 h in air and
(d) the precursor formed in step (c) was reduced in a flow of H₂ (4 mL/min) at temperature ≦750° C. for 5 h to obtain CeAl_{1-y}Ni_{y}O_{3-δ} perovskite (y=0.05).

### Example 5

### Perovskite with Platinum

(a) An aqueous solution of cerium nitrate (6.1 g), aluminum nitrate (5 g) and tetraammineplatinum (II) nitrate (0.271 g) and citric acid (7 g) were stirred at 60° C. for 2 h
(b) the solution was stirred and heated up to 80° C. to obtain a spongy material after evaporation of water;
(c) the spongy material obtained in step (b) was heated at 200° C. for 2 h to decompose the organic matter; followed by calcining the material at 500° C. for 3 h in air and
(d) the precursor formed in step (c) was reduced in a flow of H₂ (4 mL/min) at temperature ≦750° C. for 5 h to obtain CeAl_{1-y}Pt_{y}O_{3-δ} perovskite (y=0.05).

### Example 6

### Perovskite with Rhodium and Platinum

(a) An aqueous solution of cerium nitrate (6.1 g), aluminum nitrate (5 g), rhodium nitrate (0.0784 g) and tetraammineplatinum (II) nitrate (0.0271 g) and citric acid (7 g) were stirred at 60° C. for 2 h
(b) the solution was stirred and heated up to 80° C. to obtain a spongy material after evaporation of water;
(c) the spongy material obtained in step (b) was heated at 200° C. for 2 h to decompose the organic matter; followed by calcining the material at 500° C. for 3 h in air and
(d) the precursor formed in step (c) was reduced in a flow of H₂ (4 mL/min) at temperature ≦750° C. for 5 h to obtain CeAl_{1-y}Pt_{y}O_{3-δ} perovskite (y=0.05).

### Example 7

### Characterisation of AₓP₍₁₋ₓ₎B_{(1-y)}Q_{y}O_{3-δ} Type Perovskites

X-ray diffraction studies to identify the perovskite phase as well as any other impurities were carried out. The phase CeAlO₃ was formed without the presence of any impurity phase; examples of Pt, Rh and Ni incorporation are represented in FIG. 1.

### Example 8

XPS spectra of (left) Pt incorporated in the lattice of CeAlO₃ perovskite (black solid—raw peak; black dot—fitted peak; light grey—Al³⁺; black dot-dash—Pt²⁺; dark grey—Pt0); (right) Rh incorporated CeAlO₃ perovskite.

### Example 9

Autothermal reforming (ATR) of methane using the catalyst Ce_{1.0}Al_{0.975}Rh_{0.02}Pt_{0.005}O_{3-δ}

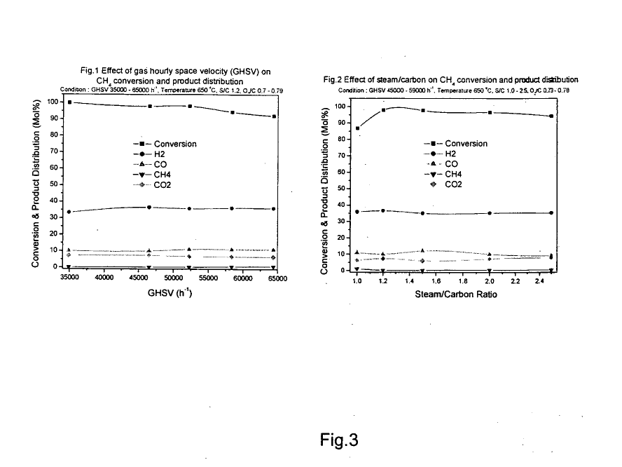

FIG. 3 shows Autothermal reforming (ATR) of methane on Ce_{1.0}Al_{0.975}Rh_{0.02}Pt_{0.005}O_{3-δ} catalyst of the invention at various space velocities. This example relates to the use of the pervoskite of the invention in autothermal reforming of methane. The effect of the activity of the catalyst due to changes in GHSV and S/C with regard to the conversion of methane. The pervosite gave 99.8% conversion of methane at a reaction temperature of 650° C., GHSV=34900 h⁻¹, S/C=1.2 and O₂/C=0.79, while the conversion dropped to 92% when the space velocity reached 64390 h⁻¹. Hydrogen and CO contents were 33.2. and 10% which were increased to 36 and 11% at higher space velocity. This catalyst was further evaluated at different SIC ratios. The effect of different S/C ratios is depicted in FIG. 3. With reference to the figure, conversion was lower than 90% at S/C=1, which increased to >99% at S/C=1.2. On further increasing the stream (S/C>1.2) content in the feed, there was a fall in the methane conversion which reached about 94% for a S/C of 2.5. Similarly, there is a slight fall in H₂ content as a result of dilution brought about by higher air required for heating the excess steam. The CO₂ had increased with a simultaneous fall in CO content.

### Example 10

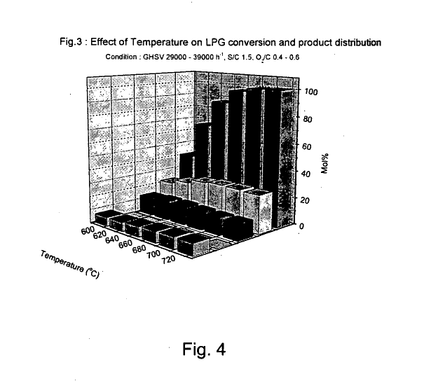

Autothermal reforming was carried out using catalysts coated on cordierite monolith substrates. The monolith catalyst was suspended in a inconnel down flow reactor. LPG and air were fed using mass flow controllers, while water was fed using metering pump to a pre-heating section. The product gas was analyzed using a gas analyzer, after condensing the excess water. FIG. 4 shows the LPG conversion, H₂ and CO contents in the reformate using Ce_{1.0}Al_{0.975}Rh_{0.02}Pt_{0.005}O_{3-δ} catalyst. The conversion was only 40.6% at 600° C., which had increased to 99.6% at 700° C. The CO and CO₂ contents were in the region of 12.5 and 81% respectively at 700° C.

### Example 11

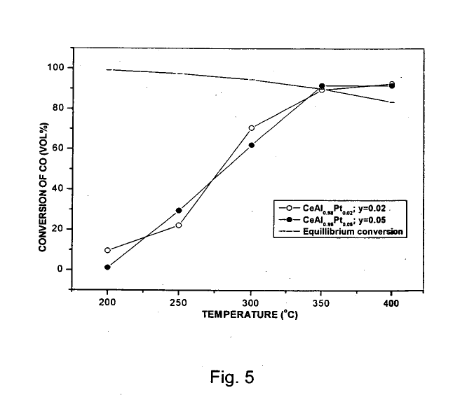

Pt containing perovskite catalysts with y=0.02 and 0.05 were evaluated for water gas shift reaction. with results as shown in FIG. 5.

FIG. 5. shows the influence of Pt content on the catalytic activity of CeAlO₃ pervoskite catalyst. Both the catalysts with y=0.02 and 0.05 show substantially similar CO conversion activity and reached equilibrium conversion at 350° C.

### Example 12

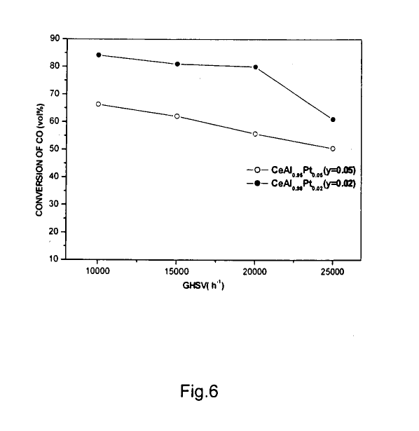

FIG. 6 shows the effect of gas hour space velocity on catalysts with y=0.02 and 0.05. It is clear that the CO conversion on perovskite catalyst with y=0.05 is higher in comparison to y=0.02 at all higher space velocities. The CO conversion falls at a much slower rate on perovskite catalyst with y=0.05 up to GHSV of 20000 h⁻¹.

We claim:

1. A perovskite represented by the following Formula (I):
AₓA′₍₁₋ₓ₎B_{(1-y)}B′_{y}O_{3-δ}
wherein A and A′ represent at least one element selected from trivalent rare earth elements of lanthanide and actinide series, including La, Ce, Pr, Nd, Sm, Eu, Gd, Tb, Dy, Th; B represents at least one element selected from Sc and group IIIA elements including, but not limited to Al, Ga, In; B′ is at least one element selected from transition metals but not limited to Ni, Cu, Co, Fe, Mn, Pt, Pd, Rh, Ru, Ir, Ag, Au wherein x=0 −1; 0≦y≦0.2 for noble metals, 0≦y≦0.5 for transition metals other than noble metals and δ represents oxygen deficiency.

2. The pervoskite according to claim 1, wherein said pervoskite forms a stable lattice network.

3. The pervoskite according to claim 1, wherein the noble metal is not sintered.

4. The pervoskite according to claim 1, wherein the pervoskite is prepared by low temperature citrate, co-precipitation and hydrothermal processes, wherein the temperature is ≦750° C.

5. The pervoskite according to claim 1 wherein said citrate process comprises:
a) stirring an aqueous solution of cerium and aluminum nitrate in molar ratio Ce:Al 1:1 at 60° C. for 2 h after the addition of citric acid in a little excess of the molar amount of Ce and Al;
b) stirring and heating the solution of step (a) up to 80° C. to obtain a spongy material after evaporation of water;
c) heating the spongy material thus obtained in step (b) at 200° C. for 2 h to decompose the organic matter;
d) calcining the material thus obtained in step (c) at 500° C. for 3 h in air to form a precursor; and
e) reducing the precursor formed in step (d) in a flow of H₂ (4-30 mL/min) at temperature ≦750° C. for 5 h to obtain CeAlO₃ perovskite
wherein for noble/transition metal incorporation, the corresponding salt of the noble/transition metal in appropriate ratio is added to the initial metal solution mixture as described in step (a) to obtain CeAl_{1-y}B′_{y}O_{3-δ}

6. The pervoskite according to claim 1 wherein said co-precipitate process comprises:
a) co-precipitating cerium and aluminium in 1:1 molar ratio in presence of KOH as precipitating agent by simultaneous addition and vigorous stirring at about 80° C. forming a gel;
b) adjusting the pH of gel as formed in step (a) to ˜9-10.5, aging the gel at 80° C. for 12 h to obtain a precipitate;
c) washing the precipitate obtained in step (b) with water till to obtain pH 7.5;
d) drying the precipitate of step (c) at 100° C. for about 12 h and calcining in air at 500° C. for 3 h to form a precursor; and
e) reducing the precursor formed in step (d) in a flow of H₂ (4-30 mL/min) at temperature ≦750° C. for 5 h to obtain CeAlO₃ perovskite
wherein for noble/transition metal incorporation, the corresponding salt of the noble/transition metal in appropriate ratio is added to the initial metal solution mixture as described in step (a) to obtain CeA1_{1-y}B′_{y}O_{3-δ}.

7. The pervoskite according to claim 1 wherein said hydrothermal process comprises.
(a) precipitating aqueous solutions of cerium and aluminum in the molar ratio 1:1 with ammonia solution to obtain a gel;
(b) transferring the gel formed in step (a) to teflon lined stainless steel autoclave and heating it at 200° C. in oven to obtain a precipitate;
(c) filtering and drying the precipitate of step (b) at 100° C. followed by calcination in air at 500° C. to form a precursor; and
(d) reducing the precursor formed in step (c) in flow of H₂ (4 ml/min) at temperature ≦750° C. at five hours to obtain CeAlO₃ perovskite,
wherein for noble/transition metal incorporation, the corresponding salt of the noble/transition metal in appropriate ratio is added to the initial metal solution mixture as described in step (a) to obtain CeAl_{1-y}B′_{y}O_{3-δ}

8. The pervoskite as claimed in claim 4 wherein said pervoskite is CeAlO₃.

9. Use of perovskite represented by the following Formula (I):
AₓA′₍₁₋ₓ₎B_{(1-y)}B′_{y}O_{3-δ}
wherein A and A′ represent at least one element selected from trivalent rare earth elements of lanthanide and actinide series, including La, Ce, Pr, Nd, Sm, Eu, Gd, Tb, Dy, Th; B represents at least one element selected from Sc and group IIIA elements including, but not limited to Al, Ga, In; B′ is at least one element selected from transition metals but not limited to Ni, Cu, Co, Fe, Mn, Pt, Pd, Rh, Ru, Ir, Ag, Au wherein x=0 −1; 0≦y≦0.2 for noble metals, 0≦y≦0.5 for transition metals other than noble metals and δ represents oxygen deficiency as catalyst for generation of hydrogen, water gas shift reaction, auto thermal reforming, steam reforming, partial oxidation, CO₂ reforming, wherein said use of pervoskite as catalyst is independent of source fuel.

10. The pervoskite as claimed in claim 6 wherein said source of fuel for ATR and steam reforming comprises LPG, methane, ethanol and lower hydrocarbons up to 8 carbons.
